(19) United States
(12) Patent Application Publication
(10) Pub. No.: US 2005/0144873 A1
(43) Pub. Date: Jul. 7, 2005

(54) Door

(75) Inventor: Peter Sibbett, Tacoma, WA (US)

Correspondence Address: BACON & THOMAS, PLLC, 625 SLATERS LANE, FOURTH FLOOR, ALEXANDRIA, VA, 22314, US

(73) Assignee: CAPSTONE ENGINEERING LTD., Gyeongnam (KR)

(21) Appl. No.: 10/872,428

(22) Filed: Jun. 22, 2004

(30) Foreign Application Priority Data
Dec. 23, 2003 (KR) 10-2003-00952219

(51) Int. Cl. E06B 3/70; E04C 2/54

(52) U.S. Cl. 52/455

(57) ABSTRACT

The present invention relates to a door that has a sufficient strength against bending and is not damaged by moisture. Front and rear plates 10 and 20 of the door of the present invention are made of a glass fiber material. A pair of transverse frames 30a and 30b made of synthetic resin and the a pair of longitudinal frames 40a and 40b made of lumber comprising bonded sheets of veneer are fixed to edge portions of the front and rear plates therebetween. Upper and lower frames of the longitudinal frames are fixedly bonded to bottom and top surfaces of the respective transverse frames so that they cannot be exposed to the outside. Further, a pair of covers 50 made of synthetic resin are attached to outer side surfaces of the longitudinal frames so that the longitudinal frames cannot be exposed to the outside. An inner space defined by the frames between the front and rear plates is filled with a foaming liquid to form a foam layer.

### BACKGROUND OF THE INVENTION

1. Field of Invention

The present invention relates to a door, and more particularly, to a door constructed to prevent moisture intrusion from the outside thereinto by forming a frame using synthetic resin and wood and providing a foam layer in the frame.

2. Description of the Prior Art

In currently mass-produced doors, their frames are mainly made of synthetic resin materials. However, when the frames are made of only synthetic resin materials, there is a disadvantage in that the doors may be bent as a whole. Due to concern about such deformation, wood has been partially used when frames of doors are formed.

In the case where wood is partially used to prevent the bending of the doors constructed as above, wood may be damaged due to moisture intrusion thereinto. This is undesirable since the reliability of the doors is greatly deteriorated.

In other words, according to the conventional doors, since the partially used wood is exposed to the outside of the doors, stains or coating agents may be peeled off from surfaces of the doors during long term use thereof, resulting in damage to the wood due to moisture intrusion thereinto. Thus, there is a disadvantage in that such damage substantially affects the life and reliability of the doors themselves.

As described above, since wood is very vulnerable to moisture, it is preferred that if a door is constructed by partially using wood, the door be constructed such that a wood portion of the door cannot be exposed to moisture.

### SUMMARY OF THE INVENTION

The present invention is conceived to solve the aforementioned problem. A primary object of the present invention is to provide a door, wherein wood is used to reinforce the strength of a frame of the door while being not exposed to moisture, thereby maintaining the strength even during long term use thereof and improving the reliability of the product.

A door according to an aspect of the present invention for achieving the object comprises front and rear plates made of a synthetic resin material; a pair of transverse frames made of a synthetic resin material and fixed at upper and lower ends of the front and rear plates therebetween; a pair of longitudinal frames made of wood and fixed at right and left side ends of the front and rear plates therebetween such that upper and lower ends of each of the longitudinal frames are in contact with bottom and top surfaces of the transverse frames, respectively; and a pair of covers made of a synthetic resin material and fixed to outer side surfaces of the longitudinal frames. An inner space defined by the frames between the front and rear plates is filled with a foaming liquid to form a foam layer.

A door according to another aspect of the present invention comprises front and rear plates made of a glass fiber material; a pair of transverse frames made of a synthetic resin material and fixed at upper and lower ends of the front and rear plates therebetween; a pair of longitudinal frames made of wood and fixed at right and left side ends of the front and rear plates therebetween such that upper and lower ends of each of the longitudinal frames are in contact with bottom and top surfaces of the transverse frames, respectively; and a pair of covers made of a synthetic resin material and fixed to outer side surfaces of the longitudinal frames. An inner space defined by the frames between the front and rear plates is filled with a foaming liquid to form a foam layer.

Ribs for coming into contact with and supporting outer side surfaces of the frames may be formed at edge portions of the front and rear plates.

A plurality of protrusions for supporting inner side ends of the frames may be formed at inner portions of the front and rear plates. The frames can be supported in place by the ribs and the supporting protrusions.

Ribs for coming into contact with and supporting outer side surfaces of the frames may be formed at edge portions of the front and rear plates, and each of the covers may be formed with wing portions that protrude at both sides of the cover to be placed inside the ribs.

The longitudinal frames may be made of laminated veneer lumber (LVL) with sheets of veneer bonded in a right and left direction. Thus, the longitudinal frames can have a sufficient strength against bending of the door in a fore and aft direction.

Contact portions of the frames with the front and rear plates and the covers may be bonded using an adhesive.

According to the present invention, since the wood having a sufficient strength against bending in a fore and aft direction is not exposed to the outside of the door, it is expected to obtain the effects of prevention of partial damage to the door due to moisture intrusion thereinto.

### BRIEF DESCRIPTION OF THE DRAWING

The above and other objects, features and advantages of the present invention will become apparent from the following description of a preferred embodiment given in conjunction with the accompanying drawing, in which:

FIG. 1 is an exploded perspective view of a door according to the present invention; and

FIG. 2 is an assembled perspective view of the door according to the present invention.

### DETAILED DESCRIPTION OF THE PREFERRED EMBODIMENT

Hereinafter, the present invention will be described in detail in connection with an embodiment illustrated in the accompanying drawings.

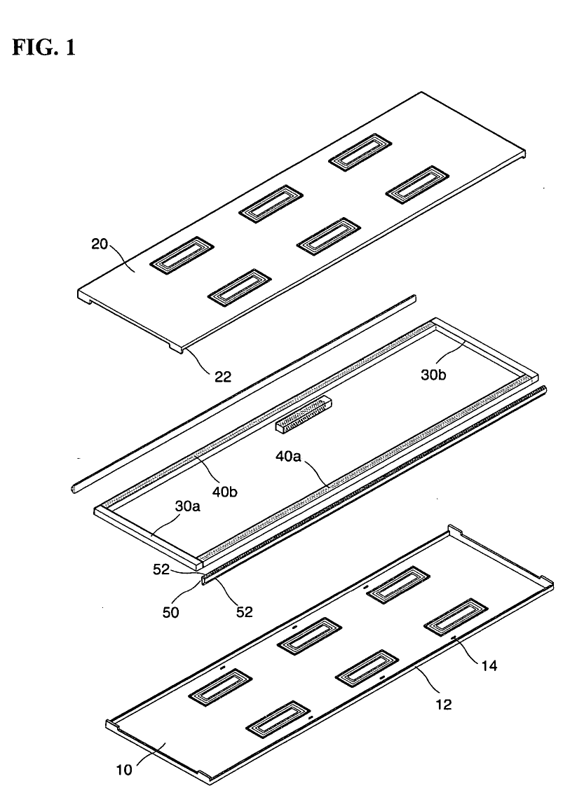

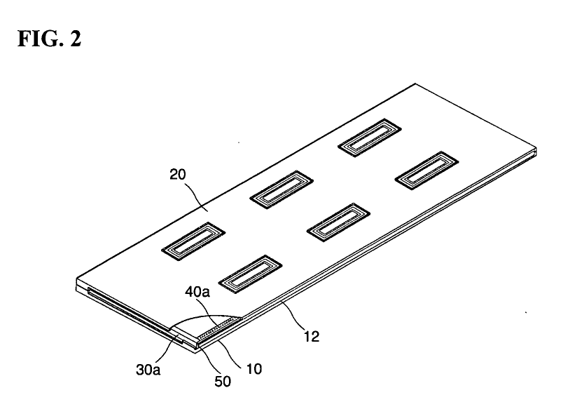

As shown in FIGS. 1 and 2, a front surface (e.g., outdoor side) and a rear surface (e.g., indoor side) of a door of the present invention are defined by a front plate 10 and a rear plate 20, respectively. The front plate 10 and the rear plate 20 can be made of a synthetic resin material and are formed into relatively thin plates. If the front plate 10 and the rear plate 20 have predetermined strengths as well as resistance to moisture intrusion, they are sufficient for the door. For example, they may be made of any kinds of synthetic resin materials.

It is preferred that the front and rear plates 10 and 20 be formed through hot pressing of glass fibers in view of their strengths. However, the materials of the plates are not necessarily limited thereto. As described above, the plates may be formed using any types of synthetic resin materials. Further, the front and rear plates 10 and 20 are constructed to have substantially symmetric shapes that are the same as each other. The front and rear plates 10 and 20 may be molded to have predetermined textures or patterns.

Since the front and rear plates 10 and 20 are substantially identical with each other, the present invention will be described hereinafter with reference to the front plate 10. Further, the orientation or direction of the door in the following description of the present invention will be based on an upright state where the door is installed.

The front plate 10 has vertical ribs 12 formed at edges thereof. The ribs 12 are to support a frame to be described later. That is, the ribs 12 support transverse frames 30a and 30b and longitudinal frames 40a and 40b while being in contact with outer side surfaces of the frames, so that the frame cannot protrude outside of the front and rear plates 10 and 20. Portions of the ribs 12 at comers of the front plate 10 may be formed to be slightly higher than the other portions thereof in order to more firmly support the frame. A plurality of supporting protrusions 14 are formed to protrude inward at an inner surface of the front plate 10 in order to support the frame between the protrusions 14 and the ribs 12. That is, the supporting protrusions 14 come into contact with and support inner ends of the transverse and longitudinal frames 30a and 30b and 40a and 40b. Therefore, the transverse and longitudinal frames 30a and 30b and 40a and 40b are maintained in a fixed state by means of the ribs 12 and the supporting protrusions 14.

As described above, the pair of transverse frames 30a and 30b and the pair of longitudinal frames 40a and 40b are installed between the front and rear plates 10 and 20. The transverse frames 30a and 30b are frames that are installed widthwise at upper and lower ends of the front and rear plates 10 and 20 and substantially define upper and lower ends of the door. Further, the transverse frames 30a and 30b are molded with a synthetic resin material, preferably with a synthetic resin material having a sufficient strength. The transverse frames 30a and 30b have the same length as the entire width of the front or rear plate 10 or 20.

The longitudinal frames 40a and 40b are frames that are installed longitudinally at right and left sides of the front and rear plates 10 and 20 and substantially define right and left sides of the door. The longitudinal frames 40a and 40b are formed out of wood having a predetermined strength. Due to the formation of the longitudinal frames 40a and 40b out of the wood, a finished door does not suffer from bending and can be firmly supported.

Since the longitudinal frames 40a and 40b are formed out of wood, they may be damaged due to moisture intrusion, resulting in great deterioration of the strength thereof. Therefore, the longitudinal frames 40a and 40b should be configured such that they are not substantially exposed to the outside of the finished door.

To this end, upper and lower ends of each of the longitudinal frames 40a and 40b are surrounded by the transverse frames 30a and 30b, respectively. That is, the upper and lower ends of the longitudinal frames 40a and 40b come into contact with and are supported by right and left portions of a bottom surface of the upper transverse frame 30b and right and left portions of a top surface of the lower transverse frame 30a, respectively.

Furthermore, the transverse and longitudinal frames 30a and 30b and 40a and 40b installed at the edges of and between the front and rear plates 10 and 20 are maintained in a state where the frames are installed between the ribs 12 and 22 and the plurality of supporting protrusions 14 of the front and rear plates 10 and 20. Here, it is preferred that the transverse and longitudinal frames and the front and rear plates be maintained in a state they are bonded to one another by means of an adhesive. The transverse and longitudinal frames between the front and rear plates should be substantially firmly supported to sufficiently withstand a foaming pressure during a foaming process that will be described later.

A pair of covers 50 are attached to right and left side ends of the longitudinal frames 40a and 40b made of wood. The covers 50 attached to the side ends of the longitudinal frames 40a and 40b protect the longitudinal frames against moisture intrusion from the outside thereinto and also substantially define right and left side ends of the door. Further, the covers 50 are made of a synthetic resin material sufficiently resistant to moisture.

The attachment of the covers 50 to the side ends of the longitudinal frames to define the right and left side ends of the door may be achieved by means of various methods. In the illustrated embodiment, wing portions 52 are longitudinally formed at the covers 50, and the door is assembled in a state where the wing portions 52 are placed inside the ribs 12 and 22 of the front and rear plates 10 and 20. The covers 50 may be more firmly attached to the longitudinal frames 40a and 40b by applying an adhesive to inner surfaces of the covers 50.

As described above, the longitudinal frames 40a and 40b made of wood are installed to prevent the occurrence of bending in a finished door having the aforementioned structure. Therefore, the longitudinal frames 40a and 40b should have a sufficient strength in a fore and aft direction to prevent bending deformation of the door in the fore and aft direction in an upright state of the door.

In this regard, to prevent the door from being bent, it is preferred that the longitudinal frames 40a and 40b be made of wood which has a sufficient strength against the bending in the fore and aft direction. To this end, the longitudinal frames 40a and 40b are made of laminated veneer lumber (LVL), as shown in the figures.

That is, LVL is made by laminating multiple sheets of veneer with a predetermined thickness using an adhesive. In the present invention, the longitudinal frames 40a and 40b are formed using LVL in which multiple sheets of veneers are laminated in a right and left direction and then fixed through bonding. In other words, when the multiple sheets of veneer are fixed in a state where they are laminated (bonded) in the right and left direction with respect to the upright state of the door, the longitudinal frames 40a and 40b substantially have a remarkably high strength against bending in the fore and aft direction. Therefore, by using LVL in which the multiple sheets of veneers are laminated in the right and left direction and then fixed through bonding, the longitudinal frames 40a and 40b can have a sufficient strength against the bending in the fore and aft direction.

As described above, when the transverse frames 30a and 30b, the longitudinal frames 40a and 40b and the covers 50 are assembled between the front and rear plates 10 and 20, the interior of the door is in a substantially empty state.

When the door is completely assembled in the empty state, the empty interior of the door is filled with a foaming liquid. Of course, it is preferred that an additional mold be used to sufficiently withstand foaming pressure during the foaming process.

Then, when a foam layer is formed by filling the interior of the door with the foaming liquid, an external finishing process is performed. Such a finishing process includes, for example, cutting the upper and lower ends of the door in correct dimensions, and surface treatment through spraying of a predetermined stain on the surface of the door. After the spraying of the stain, for example, the finishing process may further include uniformly distributing the stain on convexo-concave portions by rubbing the surface with the stain sprayed thereon with soft fabrics in order to add cubic effects to textures or patterns implemented on the front and rear plates 10 and 20. Moreover, it will be apparent that the finishing process may further include the process of spraying a predetermined coating agent after the stain is completely applied to the surface.

It will be understand that the door completed through such processes has a substantially sufficient strength against bending and simultaneously has no portions of wood exposed to the outside. Therefore, it will be apparent that damage to wood due to moisture intrusion can be sufficiently prevented.

According to the present invention described above, the longitudinal frames made of wood are assembled to be completely surrounded by the front and rear plates and the pairs of transverse frames and covers. Thus, since the wooden portions of the door are not exposed to the outside, it is possible to substantially completely prevent damage to the wooden portions of the door due to moisture intrusion. Further, since the longitudinal frames are formed using LVL in which the laminating orientation of multiple sheets of veneer is controlled, the bending of the door in the fore and aft direction can be completely prevented. Accordingly, it is expected to obtain the effects of more improvement of the reliability of the product.

It will be apparent that those skilled in the art can make various modifications within the technical spirit of the present invention described above. The present invention should be construed based on the appended claims.

1. A door, comprising:
front and rear plates made of a synthetic resin material;
a pair of transverse frames made of a synthetic resin material and fixed at upper and lower ends of the front and rear plates therebetween;
a pair of longitudinal frames made of wood and fixed at right and left side ends of the front and rear plates therebetween such that upper and lower ends of each of the longitudinal frames are in contact with bottom and top surfaces of the transverse frames, respectively; and
a pair of covers made of a synthetic resin material and fixed to outer side surfaces of the longitudinal frames,
wherein an inner space defined by the frames between the front and rear plates is filled with a foaming liquid to form a foam layer.

2. The door as claimed in claim 1, wherein ribs for coming into contact with and supporting outer side surfaces of the frames are formed at edge portions of the front and rear plates.

3. The door as claimed in claim 1, wherein a plurality of protrusions for supporting inner side ends of the frames are formed at the front and rear plates.

4. The door as claimed in claim 1, wherein ribs for coming into contact with and supporting outer side surfaces of the frames are formed at edge portions of the front and rear plates, and each of the covers is formed with wing portions that protrude at both sides of the cover to be placed inside the ribs.

5. The door as claimed in claim 1, wherein the longitudinal frames are made of laminated veneer lumber (LVL) with sheets of veneer bonded in a right and left direction.

6. The door as claimed in claim 1, wherein contact portions of the frames with the front and rear plates and the covers are bonded using an adhesive.

7. A door, comprising:
front and rear plates made of a glass fiber material;
a pair of transverse frames made of a synthetic resin material and fixed at upper and lower ends of the front and rear plates therebetween,
a pair of longitudinal frames made of wood and fixed at right and left side ends of the front and rear plates therebetween such that upper and lower ends of each of the longitudinal frames are in contact with bottom and top surfaces of the transverse frames, respectively; and
a pair of covers made of a synthetic resin material and fixed to outer side surfaces of the longitudinal frames,
wherein an inner space defined by the frames between the front and rear plates is filled with a foaming liquid to form a foam layer.

8. The door as claimed in claim 7, wherein ribs for coming into contact with and supporting outer side surfaces of the frames are formed at edge portions of the front and rear plates.

9. The door as claimed in claim 7, wherein a plurality of protrusions for supporting inner side ends of the frames are formed at the front and rear plates.

10. The door as claimed in claim 7, wherein ribs for coming into contact with and supporting outer side surfaces of the frames are formed at edge portions of the front and rear plates, and each of the covers is formed with wing portions that protrude at both sides of the cover to be placed inside the ribs.

11. The door as claimed in claim 7, wherein the longitudinal frames are made of laminated veneer lumber (LVL) with sheets of veneer bonded in a right and left direction.

12. The door as claimed in claim 7, wherein contact portions of the frames with the front and rear plates and the covers are bonded using an adhesive.
